(19) United States
(12) Patent Application Publication
(10) Pub. No.: US 2025/0080402 A1
(43) Pub. Date: Mar. 6, 2025

(54) LIMITING PEER CONNECTION ATTEMPTS BASED ON FAILURES IN PEER CONNECTION

(71) Applicant: VMware, LLC, Palo Alto, CA (US)

(72) Inventors: Saurabh Goyal, Pune (IN); Pranesh Satish Advankar, Pune (IN); Nilesh Lokhande, Pune (IN); Nikhil Hadole, Pune (IN)

(21) Appl. No.: 18/461,752

(22) Filed: Sep. 6, 2023

(51) Int. Cl. H04L 41/0663; H04L 41/0659

(52) U.S. Cl. CPC H04L 41/0663; H04L 41/0661

(57) ABSTRACT

Described herein are systems, methods, and software to manage connection attempts between gateways. In one implementation, a first gateway monitors failure information associated with a peer connection with a second gateway and determines when the failure information satisfies criteria. When the failure information satisfies criteria, the first gateway notifies the second gateway and a management service of the failure and initiates a remediation period for communications associated with the peer connection. In response to the expiration of the remediation period, the first gateway initiates a connection attempt with the second gateway.

### TECHNICAL BACKGROUND

In computing environments, gateways are used to provide connectivity for physical and virtual computing endpoints. Gateways can be used to support overlay and underlay networks, provide segmentation between different networks, or provide some other networking functionality. The gateways can be used to provide various services, including stateful services, on the ingress and egress packets to the various endpoints, including firewall operations, filtering, encryption/decryption, or some other operation with respect to the packets. For example, a packet can be received at a gateway from an external network, processed by the gateway, and forwarded to a virtual compute endpoint destination on a host.

For improved redundancy in an environment, a plurality of gateways can be deployed that can each provide stateful services for the endpoints. For example, a first gateway can be set as an active gateway, while a second gateway can be set as the standby gateway. The first gateway and the second gateway can set up a peered connection to provide updates on the stateful services, such as flow entries, firewall states, and the like. The exchange of information can be performed using border gateway protocol (BGP) in transmission control protocol (TCP) connection to provide updates from the first gateway to the second gateway. This can permit the second gateway to move to the active state after a failure of the first gateway. However, in some implementations, the connection between the first gateway and the second gateway can become unstable. This can cause the status of the gateways to fluctuate, which can cause data-path loss or instability in establishing the active gateway in the peered configuration.

### SUMMARY

The technology disclosed herein manages peer connection attempts based on failures identified in association with the peer connection. In one implementation, a method of operating a first gateway comprises monitoring failure information associated with a peer connection with a second gateway and determining when the failure information satisfies one or more criteria to prevent peer connection attempts with the second gateway. The method further includes, when the failure information satisfies the one or more criteria, initiating a remediation period that stops connection attempts for the peer connection with the second gateway during the remediation period. The method also provides identifying an expiration of the remediation period and, in response to identifying the expiration of the remediation period, initiating a connection attempt with the second gateway for the peer connection.

### BRIEF DESCRIPTION OF THE DRAWINGS

FIG. 1 illustrates a computing environment to manage peer connection attempts according to an implementation.

FIG. 2 illustrates an operation of a gateway to manage peer connection attempts according to an implementation.

FIG. 3 illustrates a timing diagram to manage peer connection attempts according to an implementation.

FIG. 4 illustrates a timing diagram to manage peer connection attempts and failure resolution according to an implementation.

FIG. 5 illustrates a gateway computing system to manage peer connection attempts in a computing environment according to an implementation.

### DETAILED DESCRIPTION

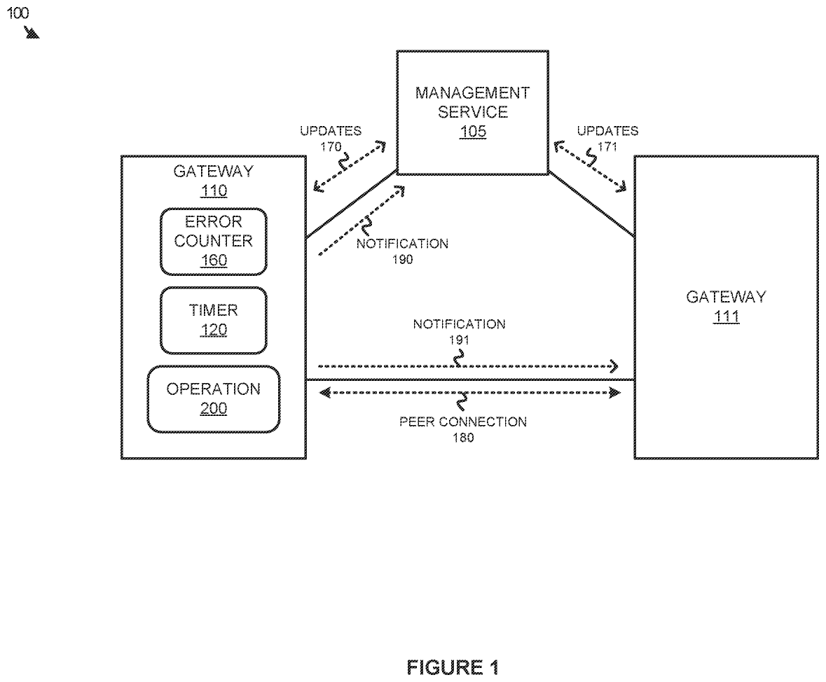

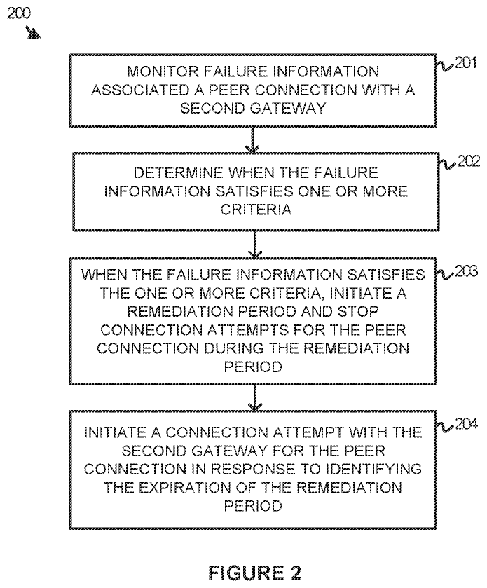

FIG. 1 illustrates a computing environment 100 to manage peer connection attempts according to an implementation. Computing environment 100 includes gateways 110-111 and management service 105. Gateway 110 further includes error counter 160 and timer 120. Gateway 110 provides operation 200 that is described further in FIG. 2. Management service 105 exchanges updates 170-171 with gateways 110-111. Gateway 110 communicates with gateway 111 using peer connection 180 and provides notifications 180-181 when failure information associated with peer connection 180 satisfies one or more criteria. Gateways 110-111 can be coupled to other gateways and other computer endpoints (not pictured) to provide the desired networking services. Management service 105 can be implemented as one or more computers. Gateways 110-111 can each be implemented on a computer, router, or some other physical device to support the operations described herein.

In computing environment 100, gateways 110-111 are deployed to provide peered or failover gateway operations for computing endpoints (physical or virtual) in the environment. Gateways 110-111 can be configured as active/standby gateways, can be configured as active/active gateways, or can be configured in some other federated environment as peers at one or more computing sites. For example, gateway 110 can be configured as an active gateway, while gateway 111 can provide a standby operation and act in place of gateway 111 after a failure of gateway 110. Gateways 110-111 can each provide various services, including stateful services on the ingress and egress packets to the computing endpoints, including firewall operations, filtering operations, encryption and decryption operations, or some other operations. The stateful information can be communicated between the gateways using peer connection 180, which can comprise a border gateway protocol (BGP) connection (in transmission control protocol TCP examples), a virtual tunnel endpoint (VTEP) connection, or some other peering connection.

In addition to peer connection 180, gateways 110-111 are coupled to management service 105 that can be used to configure the various services at the gateways. As an example, management service 105 can provide firewall rules to each gateway, indicating whether packets with different attributes should be blocked or permitted. Gateways 110-111 can further provide status information and statistical information back to management service 105, wherein the information can indicate whether the gateway is healthy, a quantity of packets received or processed by the gateway, or some other information associated with the status of the gateway.

Here, gateway 110 includes error counter 160 that is used to maintain failure information associated with peer connection 180. Error counter 160 can be used to identify the quantity of errors in the connection (e.g., connection failures), a frequency of failures in peer connection 180 between gateways 110-111, dropped packet information, or some other statistical information associated with failures in peer connection 180. From error counter 160, gateway 110 can determine when failure information associated with error counter 160 satisfy one or more criteria. The one or more criteria can include a quantity of connection failures within a period, a frequency of failures exceeding a threshold, or some other criteria. As an example, criteria for gateway 110 to identify an issue with peer connection can include ten failed connections within a five-minute period. When error counter 160 satisfies the criteria, gateway 110 can use a dampening state that is used to limit attempts associated with reestablishing peer connection 180. Gateway can stop the communication of keepalive packets in the example of a VTEP peer connection or can stop the communication of TCP connection requests in the example of a BGP peer connection.

In at least one implementation, when the criteria are satisfied, gateway 110 can notify, via notifications 190-191, management service 150 and gateway 111 that gateway 110 has identified a potential issue or failure and is moving to a dampening state. The notifications can be used to configure computing environment 100 to function in the absence of gateway 110, can be used to generate a notification that is provided to the administrator of computing environment 100 (which can be provided directly to console device of the administrator in some examples). Additionally, when the criteria are satisfied, gateway 110 can use timer 120 to stop connection requests to gateway 111 to reestablish peer connection 180. For example, timer 120 can comprise a five-minute timer that prevents gateway 110 from reestablishing peer connection 180 during the duration of the timer. Once the timer expires, gateway 110 can exit the dampening state and send a request to establish peer connection 180.

In some examples, while timer 120 is active, gateway 110 can initiate one or more remediation operations to resolve the connectivity issues associated with peer connection 180. The remediation operations can include restarting or reconfiguring one or more services on gateway 110, restarting gateway 180, or providing some other remediation operation. The remediation operations can be automatically initiated by the gateway or can be initiated by an administrator of the computing environment, wherein the administrator can select one or more remediation operations in response to the notification from gateway 110.

In some implementations, rather than employing a set timer, gateway 110 may initiate the one or more remediation operations and determine when the operations are complete. Once complete, gateway 110 can initiate a connection attempt with gateway 110. Thus, rather than using a set timer, gateway 110 can use the length of the remediation operations to determine when to permit another connection attempt with gateway 111.

Once timer 120 expires that limits the communication requests associated with peer connection 180, gateway 110 can communicate a communication request to reestablish peer connection 180. After the request, gateway 110 can monitor whether the request was successful. The success of the connection can be based on whether the connection is maintained for a threshold duration, whether the request was initially successful with gateway 111, or based on some other factor. For example, if gateway 110 identified a failed connection attempt with gateway 111 (e.g., no response), gateway 110 can determine that the dampening state was not effective in resolving the failure associated with peer connection. In response to determining that the dampening state was not successful, gateway 110 can notify management service 105 that the dampening state or reestablishment of the connection was not successful, can initiate a second dampening state to perform one or more additional remediation operations, or can perform some other action when the reestablished connection fails. Alternatively, when gateway 110 determines that the connection was successful, gateway 110 can return as a peer in the computing environment.

FIG. 2 illustrates an operation 200 of a gateway to manage peer connection attempts according to an implementation. The steps of operation 200 are referenced parenthetically in the paragraphs that follow with reference to systems and elements of computing environment 100 of FIG. 1. Although demonstrated using gateway 110, similar operations can be performed by gateway 111 to manage peer connection attempts.

In operation 200, gateway 110 monitors (201) failure information associated with a peer connection with a second gateway 111. The failure information can comprise a quantity of connection failures identified by gateway 110, a quantity of connection requests used in association with peer connection 180, timestamps associated with the failures, or some other information associated with the failure of peer connection 180. Operation 200 further determines (202) when the failure information satisfies one or more criteria. The one or more criteria can comprise a total quantity of failures associated with peer connection 180, a frequency of failures associated with peer connection 180, a quantity of failures within a period for peer connection 180, or some other criteria. As an example, gateway 110 can determine when the quantity of failures within a period satisfy a threshold quantity of failures.

In some examples, gateway 110 can maintain a score associated with the failure information, wherein the score can be derived from a variety of factors. The factors can include the quantity of failed connections, the rate of failed connections over a period, or some other factor. The score can then be compared to criteria to determine whether peer connection 180 is in a failed state.

When the one or more criteria are satisfied, operation 200 initiates (203) a remediation period and stops connection attempts for the peer connection during the remediation period. The remediation period can be a configurable period from an administrator (e.g., timer 120), can be the length of time associated with implementing one or more remediation operations, or can be some other period. As an example, gateway 110 can be configured with a five-minute remediation period that prevents gateway 110 from reestablishing the connection with gateway 111 during the remediation period. During the remediation period, an administrator or an automated process can initiate one or more remediation operations to remedy the connection issues associated with peer connection 180. As another example, gateway 110 can initiate one or more remediation operations that can be used to restart services, update a configuration, or provide some other operation to remedy the issues associated with peer connection 180. The remediation period can be the duration that the remediation operations take to complete, wherein completion can be determined based on an express notification from the administrator, a notification from the automated remediation service indicating that the operations were complete, or some other indicator to define the completion of the remediation operations. Thus, the remediation period can be a configurable or set period or can be based on the duration that remediation operations are taken to perform. The stopped connection attempts can comprise keepalive packets in the example of a VTEP peer connection or can comprise TCP connection requests in the example of a BGP peer connection.

In some implementations, in addition to implementing the remediation period, gateway 110 can communicate notifications 190-191 to management service 105 and gateway 111 to indicate that gateway 110 is moving to dampening state (i.e., timeout state) for peer connection 180. Notifications 190-191 can be used by management service 105 and gateway 111 to update the configuration of the computing environment, including assigning a gateway to provide the networking services of gateway 110, updating an active peer configuration for the environment, or some other update to support the downtime of gateway 110.

After the remediation period is initiated, operation 200 further initiates (204) a connection attempt with the second gateway for the peer connection in response to identifying that the remediation period has expired. Specifically, after the expiration of the remediation period, gateway 110 can move out of the dampening state to initiate a request to reestablish the peer connection between gateways 110-111. Returning to the example five-minute remediation period, after the expiration of the five-minute period, gateway 110 can initiate a connection attempt with gateway 111 to reestablish peer connection 180. Additionally, while gateway 110 can initiate outward connection attempts for peer connection 180 at the expiration of the remediation period, gateway 111 can initiate requests to gateway 110 that are accepted by gateway 110 at the end of the remediation period. In one implementation, when notifications 190-191 are generated, the notifications can indicate the remediation period (or an estimated remediation period) to the peer devices. Based on the information, the peer gateway (i.e., gateway 111) can delay peer connection attempts until the expiration of the period. In other implementations, gateway 110 will not indicate a remediation period, but will only accept connection requests from gateway 111 following the expiration of the remediation period.

In some examples, after attempting to reestablish the connection with gateway 111, gateway 110 can determine whether the attempt was successful or dampening state remedied the failures associated with the connection. In determining whether the attempt was successful, gateway 110 can determine whether a response is received from gateway 111, can determine whether the peer connection stays active without failure for a threshold period, or can monitor some other information associated with peer connection 180. As an example, gateway 110 can determine whether the reestablished connection is maintained for a threshold period. If the peer connection is maintained, then gateway 110 can be added to perform services in the environment. In some examples, this can include exchanging stateful information with gateway 111, providing an indication to management service 105 that gateway 110 is out of the dampening state, or providing some other action to be active in computing environment 100. If the peer connection is not maintained for the threshold period, gateway 110 can communicate notifications to management service 105 and/or gateway 111 that indicate the failure. Management service 105 can provide an administrator with a notification indicating the potential issues with peer connection 180, wherein the notification can be provided as an email, a web application, a text message, or some other notification. Additionally, if gateway 110 determines that first dampening remediation period did not resolve the issue, gateway 110 can move to a second dampening state and perform one or more additional remediation operations (e.g., service restarts, configuration updates, etc.) prior to attempting to reestablish the peer connection 180 for a second time.

Operation 200 can be repeated as necessary at gateway 110 to determine when the failure information satisfies the one or more criteria and using the dampening state to remedy the connection issues between gateway 110-111.

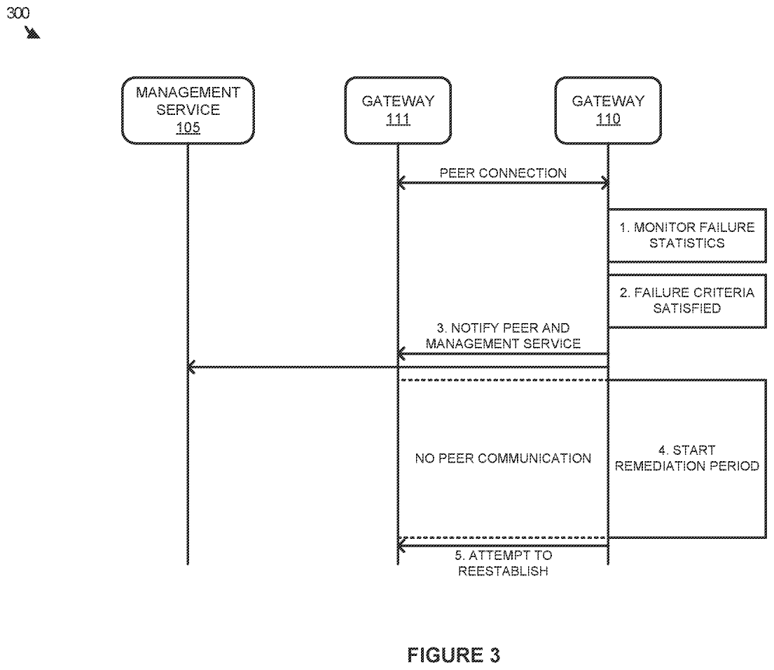

FIG. 3 illustrates a timing diagram 300 to manage peer connection attempts according to an implementation. Timing diagram 300 includes management service 105 and gateways 110-111 from FIG. 1.

In timing diagram 300, gateways 110-111 use a peer connection to exchange stateful information associated with services provided by the gateways in a computing environment. The stateful information can include health status information, can include state information associated with different services, such as firewalls, or can include some other information. The peer connection can represent a BGP connection between gateways or can represent a VTEP connection between peered VTEPs. From the peer connection, gateway 110 monitors failure information and statistics associated with the peer connection. The failure information can include the quantity of connection failures, the times associated with the connection failures, or some other information from the failures. Gateway 110 then determines when the failure information satisfies one or more criteria at step 2.

Once the criteria are satisfied, gateway 110 notifies peer gateway 111 and management service 105 that gateway 110 is going to a dampening state at step 3. The notification can be used to notify an administrator of the move to the dampening state, can be used to reconfigure and manage the computing environment, wherein the notifications can be used to move the services to an alternative set of peers, move the services to gateways 111, or provide some other operation. In at least one example, a notification can be provided to an administrator of the environment that permits the administrator to implement one or more remediation operations for the gateway (e.g., restarting one or more services, restarting the device, or providing some other operation).

In addition to notifying management service 105 and gateway 111 of the move to the dampening state and the failure at gateway 110, gateway 110 further starts a remediation period that prevents gateway 110 from establishing the peer connection during the period at step 4. The remediation period can be defined by the administrator of the environment, can be determined based on the length of one or more remediation operations at gateway 110, or can be defined in some other manner. In some examples, gateway 110 will communicate the notification to management service 105 and gateway 111 prior to starting the remediation period. In some implementations, the communication from gateway 110 to gateway 111 can be used to prevent gateway 111 from attempting to establish a peer connection with gateway 110.

After starting the remediation period, gateway 110 determines when the remediation period expires and communicates a communication request to gateway 111 to reestablish the peer connection between the gateways at step 5. As an example, gateway 110 may initiate a remediation operation to reconfigure one or more services on the gateway. Gateway 110 can determine when the reconfiguration operation is complete (i.e., expiration of the remediation period) and communicate a request to gateway 111. In another implementation, gateway 110 can identify the expiration of an administrator defined period and communicate a request to gateway 111.

Although not demonstrated in the example of timing diagram 300, gateway 110 can perform a check to determine whether the dampening state or timeout state for gateway 110 resolved the issue or failure associated with the gateway. The determination can be based on whether a connection was permitted to be established using the request from gateway 110, can be based on whether the connection is maintained for a threshold period, or can be based on some other factor. If the failure was not resolved, then gateway 110 can generate a notification for management service 105 or can reenter the dampening state to attempt additional remediation operations.

While demonstrated in the example of FIG. 3 as initiating a connection attempt from gateway 110 to gateway 111 at the expiration of the remediation period, gateway 110 can accept connection requests from gateway 111 after the expiration of the remediation period. In at least one implementation, gateway 110 can communicate a remediation period length to gateway 111, wherein gateway 111 can wait until the expiration of the remediation period before initiating a communication request. In other implementations, gateway 111 can initiate communication requests that are dropped by gateway 110 during the remediation period. However, after the expiration of the remediation period, gateway 110 is permitted to receive and process the requests from gateway 111.

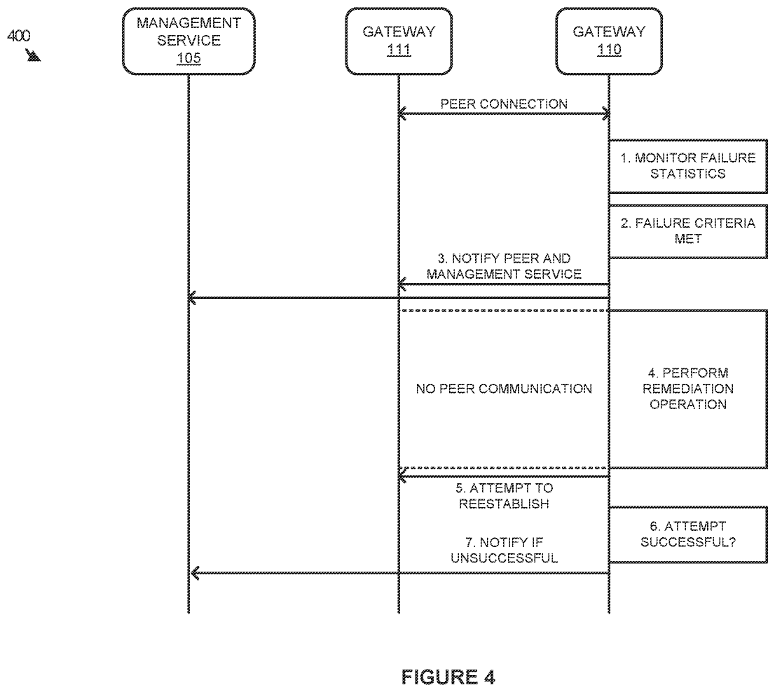

FIG. 4 illustrates a timing diagram 400 to manage peer connection attempts and failure resolution according to an implementation. Timing diagram 400 includes management service 105 and gateways 110-111 from FIG. 1.

In timing diagram 300, gateways 110-111 use a peer connection to exchange stateful information associated with services provided by the gateways in a computing environment. The stateful information can include health status information, can include state information associated with different services, such as firewalls, or can include some other information. The peer connection can represent a BGP connection between gateways or can represent a VTEP connection between peered VTEPs. From the peer connection, gateway 110 monitors failure information and statistics associated with the peer connection. The failure information can include the quantity of connection failures, the times associated with the connection failures, or some other information from the failures. Gateway 110 then determines when the failure information satisfies one or more criteria at step 2.

Once the criteria are satisfied, gateway 110 notifies peer gateway 111 and management service 105 that gateway 110 is going to a dampening state at step 3. The notification can be used to reconfigure and manage the computing environment, wherein the notifications can be used to move the services to an alternative set of peers, move the services to gateways 111, or provide some other operation. In addition to notifying management service 105 and gateway 111 of the move to the dampening state and the failure at gateway 110, gateway 110 further prevents connection attempts for the peer connection to gateway 111 and performs a remediation operation at step 4. Here, rather than using a predefined period for the dampening state and the timeout for the peer connection, the remediation period is based on the length of performing the remediation operation. For example, the remediation operation can be used to restart one or more services on the gateway to resolve the issues associated with gateway 110 and the peer connection with gateway 111. The one or more services can comprise drivers, filters, or some other service associated with the peer connection to gateway 111.

After initiating the remediation operation, gateway 110 will determine when the remediation operation is completed. In some examples, gateway 110 can determine when the service returns to an active status, can wait from a notification from the service to indicate that it is active, or can determine when the remediation is operation is complete by some other means. In response to the remediation operation being completed, gateway 110 will attempt to reestablish the peer connection with gateway 111 at step 5 and will monitor whether the connection attempt was successful at step 6.

In determining whether the connection is successful, gateway 110 can determine whether an acknowledge or response is received from gateway 111, gateway 110 can determine whether the connection is stable or active for a threshold period, or gateway 110 can determine whether the connection is successful in some other manner. For example, gateway 110 can determine whether the connection is stable for a threshold number of minutes. If stable, gateway 110 can exchange stateful information with gateway 111, can provide a notification to management service 105 indicating that gateway 110 is available, or provide some other action to be available in the environment. If the connection is not stable, gateway 110 will notify management service 105 that the connection could not be reestablished. The notification can be used by management service 105 to generate a notification for an administrator of the environment that indicates the potential issues with gateway 110.

Although demonstrated in the environment using two gateways, some computing environments can employ multiple sets of peer gateways. For example, a first set of peer gateways can be in a first data center and a second set of gateways can be in a second data center, wherein the gateways at the second data center provide a failover for the gateways at the first data center. When a failure is identified in the peer connection for the gateways at the first data center, the management service can transition to using the gateways at the second data center or provide some other failover action during the remediation period for the failed gateway. Once the remediation is complete and the potentially failed gateway leaves the dampening state (i.e., unable to reestablish the peer connection with another gateway), the management service can reconfigure the environment to use the gateway that is returning from the dampening state.

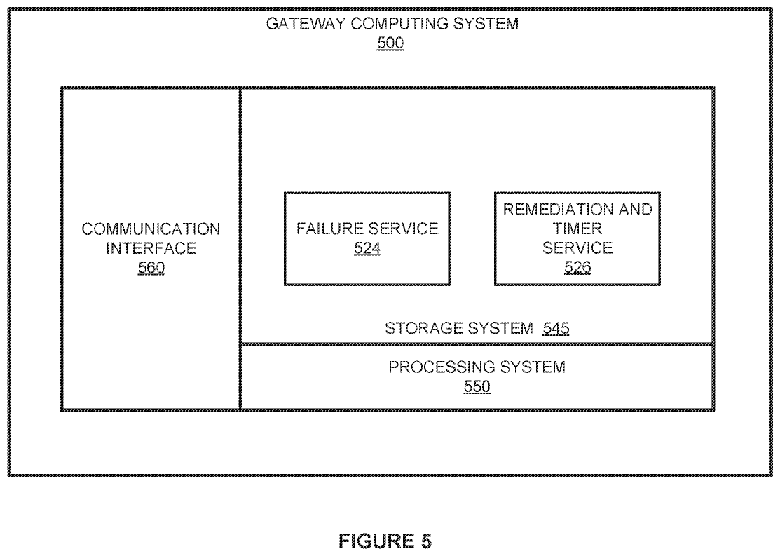

FIG. 5 illustrates a gateway computing system 500 to manage peer connection attempts in a computing environment according to an implementation. Computing system 500 is representative of any computing system or systems with which the various operational architectures, processes, scenarios, and sequences disclosed herein for a gateway can be implemented. Computing system 500 is an example of gateways 110-111 from FIG. 1 although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format-including combinations thereof. Communication interface 560 can communicate with other gateways, a management service, hosts, or other computer endpoints.

Processing system 550 comprises microprocessor (i.e., at least one processor) and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises failure service 524 and remediation and timer service 526. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least method 200 described above in FIG. 2.

In at least one implementation, gateway computing system 500 is coupled to at least one other gateway as part of a peered connection (active/active, active/standby, etc.). Failure service 524 directs processing system 550 to monitor failure information associated with a peer connection with a second gateway and determine when the failure information satisfies one or more criteria to prevent peer connection attempts with the second gateway. The failure information can indicate the quantity of failures associated with a peer connection, can indicate the frequency associated with the failures in the peer connection, or can comprise some other failure information associated with the peer connection between gateways. The one or more criteria can comprise a threshold quantity of failures, the time between failures, or some other criteria.

In some implementations, the failure information can comprise a score generated from the different failure factors (i.e., the total quantity of failures, recent frequency of failures, etc.). From the scores, failure service 524 can direct processing system 550 to generate a score, wherein each of the factors can represent different weights within the score. The score can then be compared to criteria to determine whether a failure is detected in association with the peer connection. When a failure is not detected or the criteria are not satisfied, then the peer gateway pair can maintain current operations. However, when the criteria are satisfied by the score, the gateway can stop reconnection attempts between gateway computing system 500 and the second gateway.

In some examples, when the failure occurs, in addition to preventing or limiting connection attempts associated with the peer connection, failure service 524 can communicate a notification to the peer gateway or gateways, and further communicate a notification to the management service for the computing environment indicating that gateway computing system 500 is moving to a dampening state that will stop reconnection attempts associated with the peer connection. The notification can be used by the peer gateway and the management service to reconfigure the computing environment to avoid the use of gateway computing system 500, can transition one or more alternative gateways to an active state, or can provide some other operation to support the dampening state of gateway computing system 500.

Once the one or more criteria are satisfied, remediation and timer service 526 directs processing system 550 to initiate a remediation period for the stopping the reconnection attempts associated with the peer connection. The remediation period can be a defined timer, such as a timer provided by an administrator. Alternatively, the remediation period can correspond to a remediation time on gateway computing system 500, wherein the remediation time can be used to restart one or more services, reconfigure one or more services, or provide some other remediation action to resolve the connectivity issues associated with gateway computing system 500. In response to completing the remediation action or the timer expires, remediation and timer service 526 directs processing system 550 to initiate a connection attempt with the second gateway for the peer connection.

In at least one implementation, gateway computing system 500 can determine whether the reconnection was successful with the second gateway. Gateway computing system 500 can consider whether a response was provided to the request from the second gateway, can consider whether the connection can be maintained for a threshold period, or can consider some other factor. If successful, gateway computing system 500 can exchange stateful information with the peer gateway, can notify the management service that gateway computing system 500 is no longer in the dampening state, or can provide some other action to be active in the computing environment. If the dampening state is unsuccessful (e.g., no answer is provided from the peer gateway), then gateway computing system 500 can communicate a notification to the management service to indicate the failure of the dampening state in resolving the connectivity issues. The management service can notify an administrator of the computing environment of the issue associated with gateway computing system 500.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a first gateway, monitoring failure information associated with a peer connection with a second gateway;
in the first gateway, determining that the failure information satisfies one or more criteria;
in the first gateway and in response to the determining that the failure information satisfies the one or more criteria, initiating a remediation period;
in the first gateway, preventing attempts to connect with the second gateway during the remediation period;
in the first gateway, identifying an expiration of the remediation period; and
in the first gateway and in response to identifying the expiration of the remediation period, initiating a connection attempt with the second gateway for the peer connection.

2. The method of claim 1 further comprising:
in the first gateway and when the failure information satisfies the one or more criteria, communicating a notification to the second gateway indicating a failure at the first gateway.

3. The method of claim 1 further comprising:
in the first gateway and when the failure information satisfies the one or more criteria, communicating a notification to a management service indicating a failure at the first gateway.

4. The method of claim 1, wherein stopping the connection attempts for the peer connection with the second gateway during the remediation period comprises stopping transmission control protocol (TCP) connection attempts with the second gateway or stopping a transmission of keepalive packets to the second gateway.

5. The method of claim 1, wherein the remediation period comprises a defined time duration sufficient to permit remediation operations associated with the peer connection to complete.

6. The method of claim 1, wherein the failure information comprises a quantity of failed connections with the second gateway or a rate of failed connections with the second gateway.

7. The method of claim 1 further comprising:
in the first gateway, initiating one or more remediation operations associated with one or more services at the first gateway.

8. The method of claim 7, wherein identifying the expiration of the remediation period comprises identifying when the one or more remediation operations are complete.

9. The method of claim 7, wherein initiating the one or more remediation operations comprises restarting one or more services or reconfiguring one or more services.

10. A computing apparatus comprising:
a storage system;
at least one processor operatively coupled to the storage system; and
program instructions stored on the storage system that, when executed by the at least one processor, direct the computing apparatus to:
in a first gateway, monitor failure information associated with a peer connection with a second gateway;
in the first gateway, determine that the failure information satisfies one or more criteria;
in the first gateway and in response to the determining that the failure information satisfies the one or more criteria, initiate a remediation period;
in the first gateway, preventing attempts to connect with the second gateway during the remediation period;
in the first gateway, identify an expiration of the remediation period; and
in the first gateway and in response to identifying the expiration of the remediation period, initiate a connection attempt with the second gateway for the peer connection.

11. The computing apparatus of claim 10, wherein the program instructions further direct the computing apparatus to:
in the first gateway and when the failure information satisfies the one or more criteria, communicate a notification to the second gateway indicating a failure at the first gateway.

12. The computing apparatus of claim 10, wherein the program instructions further direct the computing apparatus to:
in the first gateway and when the failure information satisfies the one or more criteria, communicating a notification to a management service indicating a failure at the first gateway.

13. The computing apparatus of claim 10, wherein stopping the connection attempts for the peer connection with the second gateway during the remediation period comprises stopping transmission control protocol (TCP) connection attempts with the second gateway or stopping a transmission of keepalive packets to the second gateway.

14. The computing apparatus of claim 10, wherein the remediation period comprises a defined time duration sufficient to permit remediation operations associated with the peer connection to complete.

15. The computing apparatus of claim 10, wherein the failure information comprises a quantity of failed connections with the second gateway or a rate of failed connections with the second gateway.

16. The computing apparatus of claim 10, wherein the program instructions further direct the computing apparatus to:
in the first gateway, initiate one or more remediation operations associated with one or more services at the first gateway.

17. The computing apparatus of claim 16, wherein identifying the expiration of the remediation period comprises identifying when the one or more remediation operations are complete.

18. The computing apparatus of claim 16, wherein initiating the one or more remediation operations comprises restarting one or more services or reconfiguring one or more services.

19. A system comprising:
a first gateway; and
a second gateway configured to:
monitor failure information associated with a peer connection with the first gateway;
determine that the failure information satisfies one or more criteria;
in response to determining that the failure information satisfies the one or more criteria:
communicate a notification to the second gateway and a management service indicating a failure at the first gateway;
initiate a remediation period; and
prevent connection attempts for the peer connection with the first gateway during the remediation period;
identify an expiration of the remediation period; and
in response to identifying the expiration of the remediation period, initiate a connection attempt with the first gateway for the peer connection.

20. The system of claim 19, wherein the failure information comprises a quantity of failed connections with the first gateway or a rate of failed connections with the first gateway.
